(19) United States
(12) Patent Application Publication
(10) Pub. No.: US 2026/0286993 A1
(43) Pub. Date: Sep. 24, 2026

(54) ADAPTIVE SYSTEM FOR SECURING RECTANGULAR MATERIALS

(71) Applicant: Magnum Tool Corporation, Inc., Houston, TX (US)

(72) Inventors: Brian Liu, Houston, TX (US); Joe Lin, Missouri City, TX (US)

(21) Appl. No.: 19/353,811

(22) Filed: Oct. 9, 2025

Related U.S. Application Data
(60) Provisional application No. 63/705,330, filed on Oct. 9, 2024.

(51) Int. Cl. F16B 2/08

(52) U.S. Cl. CPC F16B 2/08

(57) ABSTRACT

A clamp useful for securing rectangular members, where the clamp includes a front surface, a rear surface, and a top surface connecting the front and rear surfaces; and connecting element in the form of a length of material that defines an opening suitable for receiving a connecting component, the connecting element extending from a point at, or near the junction of the top surface and the rear surface; and a first screw opening extending through the top surface. The clamp may be use in combination with an adapter to accommodate rectangular members of different thicknesses (e.g., ¾ inch) such that the clamp, alone, may be used with members of a first thickness, the clamp in combination with the adapter in a first orientation may be used with rectangular members of a second thickness (e.g., ⅝ inch) and the clamp in combination with the adapter in a second orientation may be used with rectangular members of a third thickness (e.g., ½ inch). The clamp may also be used with a strap formed of a webbing material to secure rectangular members to a wall.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE DISCLOSURE

### Field of the Disclosure

The present disclosures relate to systems and methods for securing generally rectangular materials, such as drywall sheets and, more specifically, to an adaptable system for securing such materials that can be modified to provide support for items of differing thickness, for a variable number of such items and/or a combination of items of differing thicknesses.

### Description of the Related Art

Items of rectangular materials, for example, drywall sheets, pressboard sheets, plywood sheets, and other building materials, are often stacked vertically in that the largest cross-section of the item is positioned vertically with respect to a floor on which the items are stacked. One challenge faced by the vertical stacking of such materials is that such materials can potentially shift or fall resulting in the movement of items of sufficient weight to impart significant forces onto any item (or person) they may impact. Such forces have the potential to cause structural or personal damage.

In an effort to secure vertically stacked items, and avoid undesirable movements of the stacks, various apparatus and systems have been developed. For example, U.S. Pat. Nos. 10,377,584; 8,544,804; 8,317,144; and 7,543,789 each disclose a retaining system that can be used to secure vertically stacked generally rectangular materials. But these systems are believed to be limited in several respects.

For example, certain of the systems utilize a clip for attachment to a single material item (such as a single sheet of drywall). A potential limitation of such systems is that the disclosed clips are sized to optimally couple to a sheet of material having a given thickness. This can be problematic in applications where sheets of materials having different thicknesses are desired to be secured.

A further potential limitation of known systems is that they do not allow for a secure, fixed attachment between the securing system and one or more of the items to be secured. For example, in systems utilizing a clip, the clip is conventionally just slid over an edge of the material to be secured. This can create issues where repeated use and/or damage causes a distortion of the clip such that it no longer provides sufficient gripping force to securely hold the material to which it is intended to be attached in place. Similarly, in conventional systems using an arm with a projection that rests against one of the items to be secured, the arm typically has only a single point of contact with the item, such that relative movement between that point and the material, and this undesired movement of the entire stack of materials, is possible.

The systems disclosed herein are intended to overcome these and other limitations of conventional retaining systems.

It is to be understood that the discussion above is provided for illustrative purposes only and is not intended to and does not limit the scope or subject matter of the appended or ultimately issued claims or those of any related patent application or patent. Thus, none of the appended claims, ultimately issued claims or claims of any related application or patent are to be limited by the above discussion or construed to address, include, or exclude each or any of the above-cited features or disadvantages merely because such were mentioned herein.

### BRIEF SUMMARY OF THE INVENTION

A brief summary of the inventions indicating their nature and substance may be understood from the subject matter presented in the appended claims, which are incorporated herein by reference for all purposes of this summary, and by the inventions presented in any claims that may be issued from this application, which claims also are incorporated herein by reference for all purposes of this summary.

### BRIEF DESCRIPTION OF THE SEVERAL VIEWS OF THE DRAWINGS

The following figures form part of the disclosure of inventions and are included to demonstrate further certain aspects of the inventions. The inventions may be better understood by reference to one or more of these figures in combination with the detailed description of certain embodiments presented herein.

FIGS. 1A-1C illustrate an exemplary base clamp 100 that may be used in one or more embodiments of the exemplary systems disclosed herein.

FIGS. 2A-2B illustrate exemplary elements of an embodiment of a connecting component 200 that may be used in one or more embodiments of the exemplary systems disclosed herein to facilitate use of the systems with stacks of differing numbers of items of stacked material.

FIGS. 3A-3C illustrate an exemplary adapter 300 that may optionally be used in one or more embodiments of the exemplary systems disclosed herein to facilitate use of the systems with material items of differing thicknesses.

FIGS. 4A-4C illustrate various alternative approaches for using the base clamp 100 without or with the adapter 300 used in one or more embodiments of the exemplary systems disclosed herein to facilitate use of the systems with material items of differing thicknesses.

FIGS. 5 and 6A-6C illustrate an alternate embodiment of a system that may be used to secure a stack of vertically stacked materials that include an exemplary fixed length strap structure 500 and a generally L-shaped retaining clip 600.

FIGS. 7A-7B illustrate an exemplary use of the exemplary system of FIGS. 5 and 6A-6C.

While the inventions disclosed herein are susceptible to various modifications and alternative forms, only a few specific embodiments have been shown by way of example in the drawings and are described in more detail below. The figures and detailed descriptions of these embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts illustrated and taught by the specific embodiments.

### DETAILED DESCRIPTION

The Figures described above, and the written description of specific structures and functions below, are not presented to limit the scope of the inventions disclosed or the scope of the appended claims. Rather, the Figures and written description are provided to teach a person skilled in this art to make and use the inventions for which patent protection is sought.

A person of skill in this art having benefit of this disclosure will understand that the inventions are disclosed and taught herein by reference to specific embodiments, and that these specific embodiments are susceptible to numerous and various modifications and alternative forms without departing from the inventions we possess. For example, and not limitation, a person of skill in this art having benefit of this disclosure will understand that Figures and/or embodiments that use one or more common structures or elements, such as a structure or an element identified by a common reference number, are linked together for all purposes of supporting and enabling our inventions, and that such individual Figures or embodiments are not disparate disclosures. A person of skill in this art having benefit of this disclosure immediately will recognize and understand the various other embodiments of our inventions having one or more of the structures or elements illustrated and/or described in the various linked embodiments. In other words, not all possible embodiments of our inventions are described or illustrated in this application, and one or more of the claims to our inventions may not be directed to a specific, disclosed example. Nonetheless, a person of skill in this art having benefit of this disclosure will understand that the claims are fully supported by the entirety of this disclosure.

Those persons skilled in this art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art having benefit of this disclosure.

Further, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the scope of what is claimed.

Reference throughout this disclosure to “one embodiment,” “an embodiment,” or similar language means that a particular feature, structure, or characteristic described in connection with the embodiment is included in at least one of the many possible embodiments of the present inventions. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of one embodiment may be combined in any suitable manner in one or more other embodiments. one or more of the specific details, or with other methods, components, materials, and so forth. In other instances, well-known structures, materials, or operations are not shown or described in detail to avoid obscuring aspects of the disclosure.

The description of elements in each Figure may refer to elements of proceeding Figures. Like numbers refer to like elements in all figures, including alternate embodiments of like elements.

For purposes of the present disclosure the described embodiments will be discussed in the context of an application where they are used to secure a stack of generally rectangular materials, where the stacked materials take the form of drywall sheets. It will be understood, however, that applications of the disclosed systems are not limited to the securing of only drywall sheets. As will be appreciated by one having the benefit of this disclosed systems can be used to secure any generally rectangular items including but not limited to: drywall sheets; slabs (e.g., marble granite, composite materials); metallic plates (e.g., steel, aluminum), glass, plywood, wood, or other composite panels (fiberglass, foamboard). It will be further understood that reference to a “rectangular” item of material is intended to encompass material items that have a generally square surface profile (e.g., 2 ft by 2 ft) as well as items having a traditional rectangular profile (e.g., 4 ft×8 ft, 4 ft×12 ft., or 4 ft×16 ft).

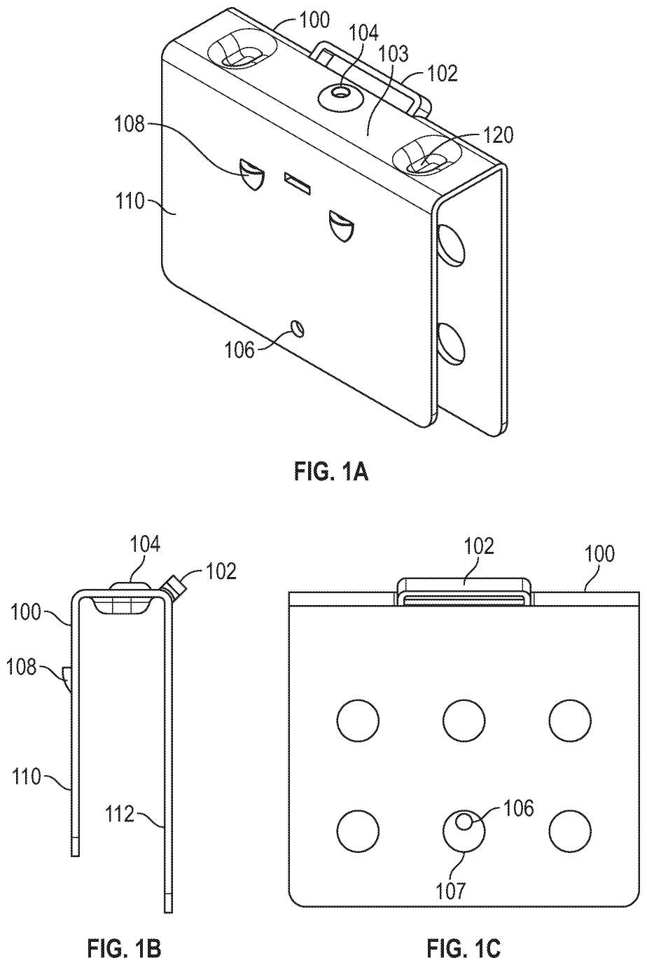

Turning now to several descriptions, with reference to Figures, of particular embodiments incorporating one or more aspects of the disclosed inventions, FIGS. 1A-1C illustrate aspects of an exemplary base clamp 100 that may be used in one or more embodiments of the exemplary systems disclosed herein. FIG. 1A illustrates a perspective view of the clamp 100, FIG. 1B illustrates a side view of the clamp, and FIG. 1C illustrates a rear view of the clamp.

In the illustrated example, the base clamp 100 is formed from stamped and manipulated metal (e.g., steel, aluminum, etc.). Alternate embodiments are envisioned, however, in which the base clamp is formed from a cut material (e.g., laser or water jet cut metal); a cast material (e.g., an iron composite); a forged material; or a 3D printed material.

Referring to FIGS. 1A-1C it will be seen that the exemplary clamp 100 includes a connecting element 102, which in the illustrated example takes the form of a length of material that defines a generally rectangular opening suitable for receiving a connecting component, such as a strap. It will be noted that, in the illustrated example of FIGS. 1A-1C, the clamp 100 defines a front surface 110, a rear surface 112, and a top surface 103 connecting the front and rear surfaces and that the connecting element extends from a point at, or near the junction of the top surface 103 and the rear surface 112.

As best shown in FIGS. 1A and 1B, the exemplary clamp 100 further defines a first screw opening 104 that extends through the top surface. As best reflected in FIGS. 1A and 1B the first screw opening is positioned at a point that is roughly half-way between the side edges of the clamp 100 (e.g. the left and right most portions of the clamp in FIG. 1A) and at a point that is closer to the rear surface 112 of the clamp 100 than the front surface 110.

As further shown in FIG. 1A, in the exemplary embodiment, depressed or dimpled features (one of which is designated as 120) are provided on opposite sides of the screw opening 104. These features provide a bit of offset distance between the underside of the top surface 103 and the top surface of the material to be secured. Such offset allows a screw passing through screw opening 104 to be slightly angled to enter the material and run closer to the center of its thickness. Alternative embodiments are envisioned wherein such features are eliminated and/or the screw opening 104 is changed from a raised dimpled hole (as shown in FIG. 1A) to a flat slot extending along top surface 103 partly between but not all the way from side 110 to side 112

As best shown in FIG. 1B, a curved surface connects the top surface of the clamp 100 to the front 110 and rear surfaces 112. As further shown in FIG. 1B, in the illustrated example the longitudinal length of the front and rear surfaces varies, with the longitudinal length of the front surface (i.e., the vertical length in FIG. 1B) being less than the longitudinal length of the rear surface 112.

Referring to FIGS. 1A and 1C, it may be noted that the front surface 110 of the clamp 100 defines a second screw opening 106. In the illustrated example of FIGS. 1A-1C, the first and second screw openings are of the same dimensions, but this need not be the case.

Referring to FIG. 1C, it will be noted that in the illustrated example, the rear surface 112 defines a plurality of openings including one opening 107 that includes within its diameter the location of the second screw opening 106 such that an imaginary ray passing through the second screw opening would pass through such opening. This opening allows for the passage of a screw through the second screw opening 106, a material item to which the clamp 100 is to be coupled, and through the opening 107, such that the head of the screw may be relatively flush with the surface 110 while the tip of the screw extends, through opening 107, out of the surface 112.

Further referring to FIGS. 1A and 1C, it will be seen that the front surface of the exemplary clamp 100 defines two clamp engagement elements 108 (only one of which is labeled). In the illustrated example, such clamp engagement elements 108 are outwardly extending and positioned on opposite sides of the second screw opening 106.

In one embodiment, the distance between the internal faces of the front 110 and rear surfaces (i.e., the space bounded on three sides by the inner faces of the front surface 110, the top surface 103 and the rear surface 112) can be selected to correspond to the greatest thickness of the materials for which the clamp 100 is intended to be used. For example, for an embodiment in which the clamp 100 is anticipated to be used with drywall sheets (which conventionally come in thicknesses of ½ inch, ⅝ inch, and ¾ inch) the distance between the inner surfaces of the first and rear faces can be set to correspond to ¾ inch. By indicating that the distance can correspond to ¾ inch, it will be understood that the distance need not be exactly ¾ inches and that such distance can, for example, be ¾ inches, less than ¾ inches (such that the front and rear surfaces of the clamp 100 will have to be sprung open to fit the clamp on a ¾ inch thick sheet of drywall), or greater than ¾ inch (such that a retaining component such as a screw can be passed through the second screw opening 106 and/or first screw opening 104 to secure the clamp to a ¾ inch drywall sheet).

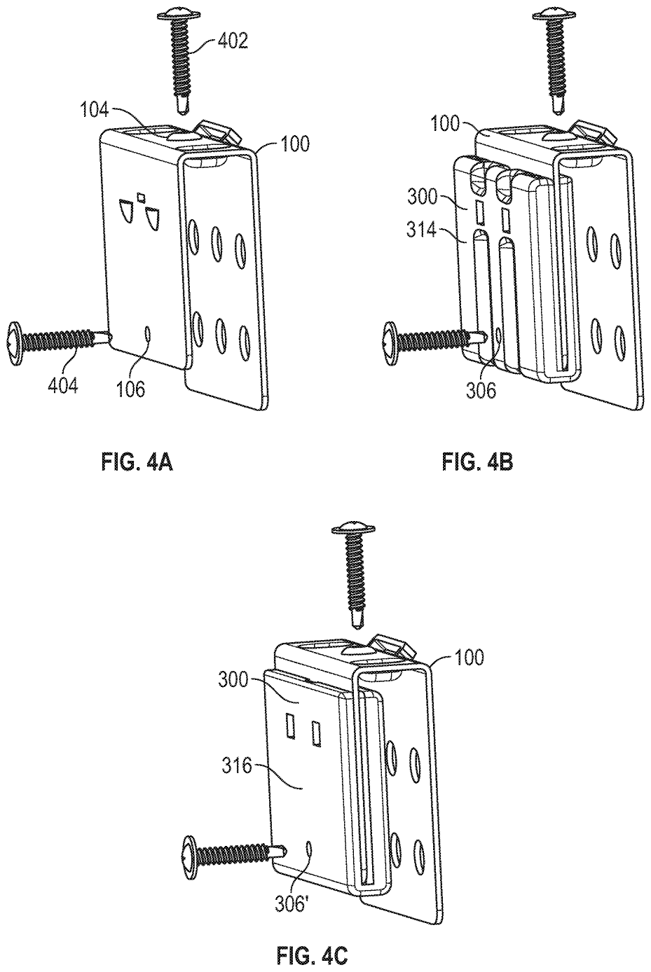

Referring to FIG. 4A, it will be understood that the clamp 100 of FIGS. 1A-1C can be secured to an item of rectangular material to be secured by placing the clamp over one of the edges of the item to be secured and (optionally) passing a connecting element (e.g., a screw 402) through the first screw opening 104, the second screw opening 106 or both. In the example of FIG. 4A, the first and second screw openings are of the same dimension, such that screws of the same size could be used. Further, in the example of FIG. 4A, each of the screws 402 is self-tapping such that they can be utilized in such a manner that they can pass through their respective screw opening and into the material of the item to be retained (e.g., into a dry wall sheet).

While self-tapping screws 402 are used in the example of FIG. 4A, it will be appreciated that other coupling structures can be used such as nails, non-self-tapping screws, screws with contact surfaces (e.g., a rubber tip) that can be advanced and compressed against the material to be secured, and/or a plate coupled to an advancing element that can be advanced to contact a surface of material to be secured.

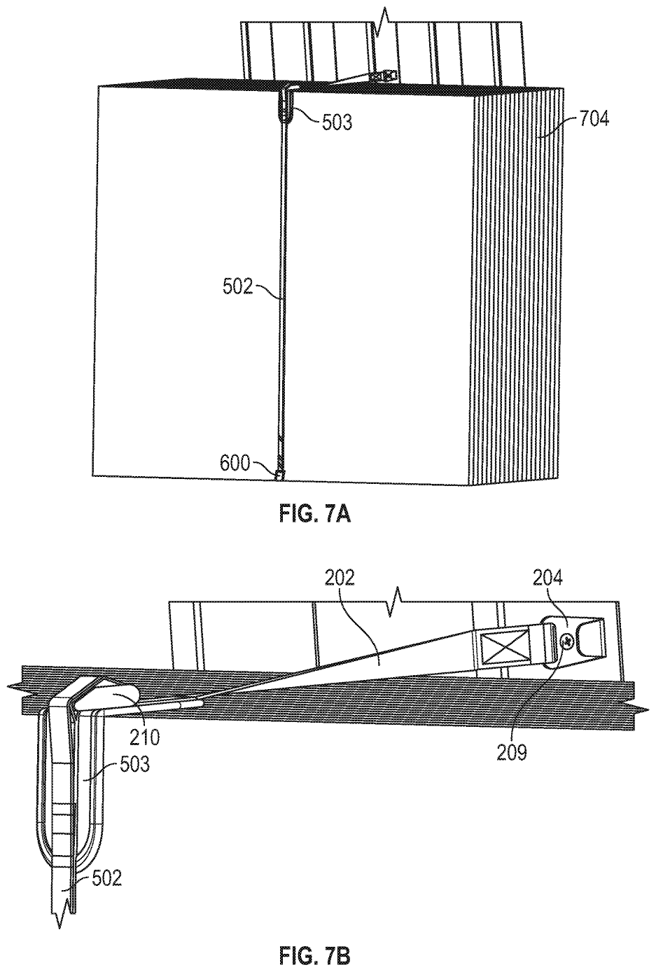

As will be appreciated, using the clamp 100 a vertical stack of generally rectangular materials may be secured in the following manner. First, a stack of such materials may be created by vertically stacking a plurality of items of such materials against a structure (an example of such a stack is provided by stack 704 in FIG. 7. Second, the clamp 100 may be coupled to the item of stacked material most distant from the structure against which the first stack item rests (e.g., the outer facing item in FIG. 7). In one embodiment, the clamp 100 will be positioned such that the front surface 110 of the clamp is exposed and the rear surface 112 of the clamp is positioned between the outermost item to be secured and the next item in the stack. Third, the clamp 100 may be secured in place by passing a connecting component through the opening defined by the connecting element 102 and attaching the connecting component to an immovable (generally immovable structure) such that movement of the clamp 100 will be inhibited.

The connecting component used to secure the clamp 100 to an immovable (or generally immovable) structure may take many forms including wire, rope, or a line of suitable strength. The immovable/generally immovable structure may take the form of an exposed stud, a board, a pipe, a heavy item of equipment or any element sufficiently immovable to hold the material stack in place.

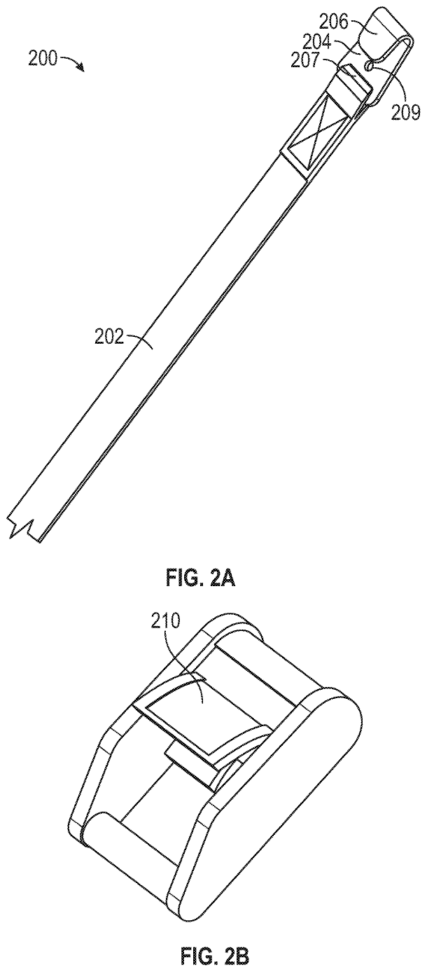

In one exemplary embodiment, the connecting component may take the form of the connecting component 200, elements of which are depicted in FIGS. 2A and 2B.

Referring first to FIG. 2A, the exemplary coupling component includes a strap 202, that may be formed of webbing materials, having a first end that is passed through a strap opening 207 in a connection clip 206 and then sewn back to a position of the strap 202. As will be appreciated, in this example, the passage of an end of the strap through an opening of the connection clip 206, and the sewing of the end back to the strap, fixedly attaches the clip 206 to the strap.

The clip 206 may be formed from stamped and manipulated metal or using any of the materials and processes described above in connection with clamp 100.

As further reflected in FIG. 2B, the clip 206 defines a hook element 206 and a clip screw opening 209. As will be appreciated, the inclusion of both the hook 206 and the clip screw opening 209 allows the first end of the coupling component 200 to be secured to a structure, such as a wall stud a pipe, a board, or any other suitable structure, by: (a) affixing the clip 206 to the structure via a screw placed through clip screw opening 209, and/or (b) wrapping the first end of the coupling component around a structure (e.g., an exposed stud or a pole) and connecting the hook 206 to an exposed portion of the strap 202) and/or (c) connecting the hook 206 to an edge of an exposed surface.

In the example of FIGS. 2A-2B, while the first end of the coupling component is attached to a fixed structure, the opposite end (e.g., the second end), not depicted in FIG. 2B may be coupled to the clamp 100 in such a manner that the length of the portion of the strap 202 extending between the clamp 100 and the clip 206 may be adjusted. For example, in one embodiment, the second end of the strap 202 may be passed through the opening defined by the clamp's connecting element 102 and passed through an adjustment element coupled to the strap (such as the ratcheting clamp 210 of FIG. 2B) and the strap then pulled through the adjustment element until the distance between the clamp 100 and coupling of the clamp 100 to one item within the material stack and (b) the coupling of the first end of the strap 202 to an immovable (or generally immovable) structure is set to a desired length.

It will be appreciated that the ability to adjust the length of the strap 202 extending between the clamp 100 and the clip 206 allows the disclosed structure to be used with material stacks of differing thicknesses. It will also be appreciated that the ratcheting clamp 210 of FIG. 2B is only one example of a structure that can be used to adjust the length of the strap between the clamp 100 and the clip 206. Alternative adjusting structures can be used including, but not limited to, buckles, sliders, and/or an adjustable ratcheting mechanism.

As described above, the distance between the inner surfaces of the front 110 and rear sides 112 of the clamp 100 of FIGS. 1A-IC can be selected to correspond to the greatest thicknesses of the materials to be secured by the disclosed system. However, certain materials can come in a variety of thicknesses. For example, as noted above, drywall conventionally comes in thicknesses of ⅝ inch, ½ inch, and, less commonly, ¾ inch. And a clamp 100 having a distance between the inner surfaces of sides 110 and 112 corresponding to ¾ inch, may not be ideally suited for retaining a stack of material items each having a thickness of either ½ inch or ⅝ inch. To address this issue, the clamp 100 of FIGS. 1A-1C may be combined with an adapter element.

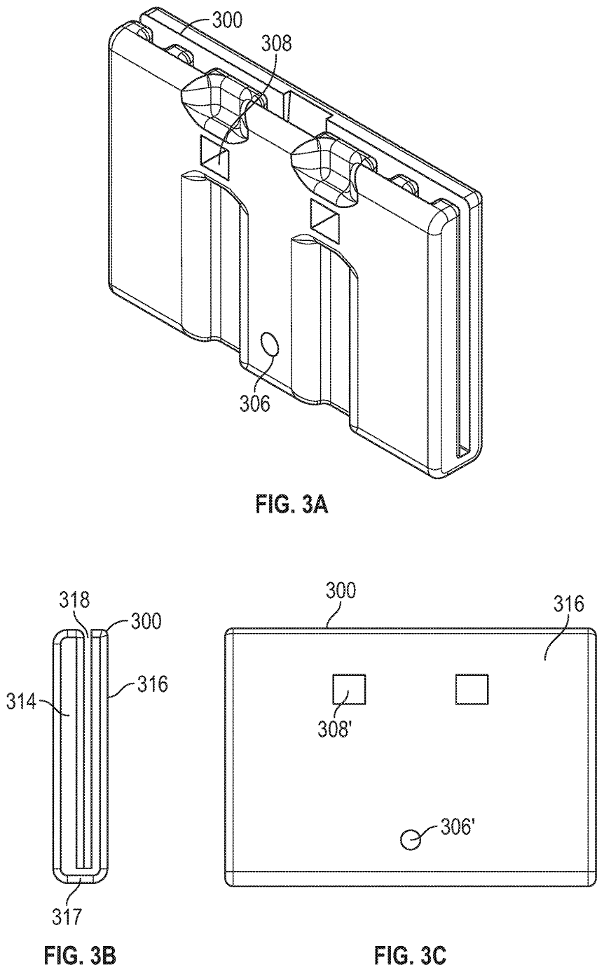

FIGS. 3A-3C illustrate one example of an adapter element 300 that may be used with the clamp 100 of FIGS. 1A-1C.

Referring to FIGS. 3A-3C, an adapter 300 is depicted that has a generally U-shaped appearance that includes a first side portion 314 of a first thickness; a second side portion 316 of a second thickness, and a bottom portion 317 connecting the first and side portions. Because of the generally U-shaped nature of the adapter 300, an upwardly open space is defined that is open at the top and that is bounded on three sides by the inner surfaces of the first portion 314, the bottom portion 317 and the second side portion 316. In the example of FIGS. 3A-3C, the longitudinal lengths of the first and second side portions (i.e., the top to bottom lengths in FIG. 3B) are the same (at least within 5%), and the thickness of the first side portion 314 is greater than the thickness of the second side portion 316.

The adapter 300 may be formed from stamped and manipulated metal, an injection molded material, or using any of the materials and processes described above in connection with clamp 100.

In the example of FIGS. 3A-3B, at least the inner surfaces of each of the first side portion 314 and the second side portion 316 define two adapter engagement features (308 first side portion 314/308′ second side portion 316) and one screw opening (306 first side portion 314/306′ second side portion 316). In this example, each of the adapter engagement features 308/308′ takes the form of an opening sized and configured to receive one of the clamp engagement features 108 described above in connection with FIGS. 1A-1C. In the same example the adapter screw openings 306/306′ are sized and configured to receive the same size and form connecting element (e.g., screw 402) as the second screw opening 106 described in connection with FIGS. 1A-1C.

FIGS. 4A-4C depict the manner in which the adapter 300 may be used with the clamp 100 to couple the disclosed system to materials of differing thicknesses. As described above, the configuration of FIG. 4 may be used to couple the disclosed clamp 100 to a material having a first thickness (e.g., a thickness of ¾ inch).

FIG. 4B, alternatively, shows an arrangement where the adapter 300 is coupled to the clamp 100 by sliding the front edge 110 of the clamp 100 into the open space of the adapter 300. In the illustrated example, such a configuration will result in the engagement features 108 of the clamp 100 engaging with the engagement features 308 of the first side portion 314 of the adapter such that the second portion of the adapter 316 is positioned in the space between the first side of the clamp 110 and the second side of the clamp 112. As will be appreciated from an inspection of FIG. 4B, this arrangement effectively decreases the thickness of the opening of the clamp 100/adapter 300 combination, providing an arrangement that can be better secured to a material having a second thickness (e.g., ⅝ inch) that is less than the first thickness (e.g., ¾ inch).

As will also be appreciated from FIG. 4B, the combination of the clamp 100 and the adapter 300 may be coupled to an item of materials using coupling elements (e.g., screws) in the same manner as described above in connection with the clamp 100 of FIG. 4A.

Because the thickness of the first side 314 of the exemplary adapter 300 is different from the thickness of the second side 316, the orientation of the adapter 300 relative to the clamp 100 can also be as depicted in FIG. 4C. In this orientation the first side 314 of the adapter is positioned in the space between the first side of the clamp 110 and the second side of the clamp 112. As will be appreciated from an inspection of FIG. 4C, in the same manner described above with respect to FIG. 4B, this arrangement effectively further decreases the thickness of the opening of the clamp 100/adapter 300 combination as compared to the opening size in FIG. 4B, providing an arrangement that can be better secured to a material having a third thickness (e.g., ½ inch) that is less than both the first thickness (e.g., ¾ inch) and the second thickness (e.g., ⅝ inch).

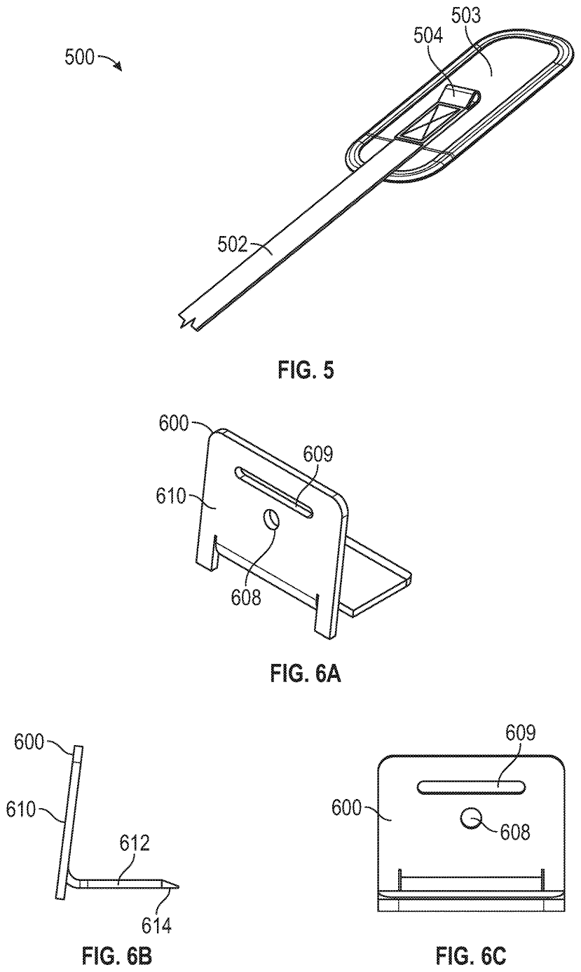

For certain applications it may be beneficial to use a retaining structure having a structure different from that previously described in stead of or in combination with the previously described retaining system. For example, when relatively hard materials (e.g., granite or marble) will be retained that cannot be penetrated by a coupling element like a screw, or when no edges of the materials to be retained can be marred by contact with a coupling element an alternative retaining structure may be beneficial. FIGS. 5, and 6A-6C and 7A-7B illustrate such an alternative structure

Referring first to FIG. 5 a first component 500 of the alternative retaining system is illustrated. In the illustrated example, the component 500 includes a strap 502 of fixed length that has a first end fixedly attached (e.g. by sewing) to a protective pad 503. The strap 502 may be formed from the same materials described above in connection with element 202. The protective pad 503 may be formed from cloth, cloth and padding, or any other material suitable for contact with the items of material to be retained by the system.

In the illustrated example, the fixed length strap 502 includes a second end (not illustrated) that is fixedly coupled (e.g., by sewing) to a lower retaining clip. While the length of the strap will vary from embodiment to embodiment, the length should be selected to correspond with one of the dimensions of the material items to be retained by the system. For example, in embodiments where the retained materials are to have dimensions of 4 ft by 8 ft, the length of strap 502 can be selected to correspond to 4 feet.

FIGS. 6A-6C illustrate an exemplary lower retaining clip 600. The clip 600 may be formed in the manner described above with respect to clamp 100 and may, for example, be formed from stamped and manipulated metal. As shown in FIGS. 6A-6C the lower retaining clip 600 is generally L-shaped and includes an upwardly extending surface 610 that defines a lower clip strap opening 609, configured to receive the second end of the strap 502 described above. The clip 600 further defines a lower clip screw opening 608 (that may be used in a manner like that described above with respect to screw opening 106). The clip further defines an outwardly extending surface 612 that extends at an angle from surface 610. In the illustrated embodiment, the interior angle between the surfaces 610 and 614 is less than 90 degrees.

As best shown in FIG. 6B, in the illustrated example, the surface 612 terminates in a beveled section 614.

FIGS. 7A and 7B illustrate the manner in which the components of FIGS. 5 and 6A-6C may be combined with the components of FIGS. 2A-2B to provide an alternative retaining system. For example, as shown in FIG. 7B, a ratcheting clamp 210 (as depicted in FIG. 2B may be fixedly coupled to an exemplary protective pad 503. The second end of the strap 202 may then be passed through the clamp 210.

Referring now to FIG. 7B, the combination of FIG. 7A may be used to secure a vertical stack of material 704 by placing the lower clip 600 under the lower side of the outer item of material to be retained, coupling the first end of the strap 202 to a stationary structure (e.g., by passing a screw through the connecting clip screw opening 209) and the second end of the strap 202 may be pulled tight through the ratchet clamp 210.

It will be appreciated that, because the fixed length of the strap 502 was selected to correspond to one dimension of the material to be retained, the disclosed arrangement encourages storage of the materials in one orientation. For example, if the strap 502 has a fixed length corresponding to 4 ft, and the material to be stored has dimensions of 4 ft.×12 ft., the fixed length of strap 502 encourages storage of the materials in an orientation where the longest side of the material (e.g., the 12 ft side) is positioned parallel to the floor on which the stored materials rest.

Other and further embodiments utilizing one or more aspects of the inventions described above can be devised without departing from the spirit of Applicant's invention. Further, the various methods and embodiments of the methods of manufacture and assembly of the system, as well as location specifications, can be included in combination with each other to produce variations of the disclosed methods and embodiments. Discussion of singular elements can include plural elements and vice-versa.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to protect fully all such modifications and improvements that come within the scope or range of equivalent of the following claims.

What is claimed is:

1. A clamp useful for securing rectangular members, the clamp comprising:
a front surface, a rear surface, and a top surface connecting the front and rear surfaces;
a connecting element in the form of a length of material that defines an opening suitable for receiving a connecting component, the connecting element extending from a point at, or near the junction of the top surface and the rear surface; and
a first screw opening extending through the top surface.

2. The clamp of claim 1, wherein the base clamp is formed from stamped and manipulated metal.

3. The clamp of claim 1, wherein the opening defined by the connecting element is generally rectangular in shaped and sized to receive a connecting component in the form of a strap.

4. The clamp of claim 1 wherein the first screw opening is positioned at a point that is roughly half-way between the side edges of the clamp and at a point that is closer to the rear surface of the clamp than the front surface of the clamp.

5. The clamp of claim 1 further comprising depressed or dimpled features on opposite sides of the screw opening to provide an offset distance between the underside of the top surface of the clamp and the top surface of a rectangular member to which the clamp may be secured.

6. The clamp of claim 1 wherein the front surface defines a second screw opening.

7. The clamp of claim 6 wherein the rear surface 112 defines a plurality of openings including a rear screw opening that includes within its diameter the location of the second screw opening such that an imaginary ray passing through the second screw opening would pass through the rear screw opening.

8. An adaptive clamping system useful for securing rectangular members of varying thicknesses, the system comprising:
(1) a clamp comprising:
(a) a front surface, a rear surface, and a top surface connecting the front and rear surfaces, wherein the longitudinal length of the front and rear surfaces varies, with the longitudinal length of the front surface being less than the longitudinal length of the rear surface; wherein the distance between the internal faces of the front and the rear surfaces generally correspond to a first thickness associated with rectangular members to be secured by the system;
(b) a connecting element in the form of a length of material that defines an opening suitable for receiving a connecting component;
(c) a first screw opening extending through the top surface;
(d) a plurality of clamp engagement members extending from one or both of the front and/or rear surfaces; and
(2) generally U-shaped adapter that includes a first side portion of a first thickness; a second side portion of a second thickness, a bottom portion connecting the first and side portions, and an upwardly open space bounded on three sides by inner surfaces of the first portion, a plurality of adapter engagement members extending from one or both of the first and/or second side portions of the adapter and an adapter screw openings extending through both the first and the second side positions of the adapter; wherein the adapter is positioned such that one of the front or the rear surfaces of the clamp is received in the upwardly open space of the adapter and such that the plurality of adapter engagement members engage the plurality of clamp engagement members to retain the adaptor in a stable position with respect to the clamp.

9. The adaptive clamping system of claim 8 wherein the adapter is formed of injection molded material.

10. The adaptive clamping system of claim 8 wherein the distance between the inner front surface of the claim and the inner rear surface of the clamp corresponds to a first thickness of a first rectangular element that may be secured by the clamping system.

11. The adaptive clamping system of claim 10 wherein the first thickness is ¾ inch.

12. The adaptive clamping system of claim 10 wherein the adapter is positioned relative to the clamp such that the first side portion of the adapter is positioned between the inner front surface of the clamp and the inner rear surface of the clamp and such that the distance between the outer surface of the first side portion and the inner rear surface of the clamp corresponds to a second thickness of a second rectangular element that may be secured by the clamping system.

13. The clamping system of claim 12 wherein the second thickness is ⅝ inch.

14. The adaptive clamping system of claim 10 wherein the adapter is positioned relative to the clamp such that the second side portion of the adapter is positioned between the inner front surface of the clamp and the inner rear surface of the clamp and such that the distance between the outer surface of the second side portion and the inner rear surface of the clamp corresponds to a third thickness of a third rectangular element that may be secured by the clamping system.

15. The adaptive clamping system of claim 14 wherein the third thickness is ½ inch.

16. The adaptive clamping system of claim 10 wherein the first thickness of the first side portion of the adapter and the second thickness of the second side position of the adapter are selected such that:
when the first side portion of the adapter is positioned between the inner front surface of the clamp and the inner rear surface of the clamp and such that the distance between the outer surface of the first side portion and the inner rear surface of the clamp corresponds to a second thickness of a second rectangular element that may be secured by the clamping system
when the adapter is positioned relative to the clamp such that the second side portion of the adapter is positioned between the inner front surface of the clamp and the inner rear surface of the clamp and such that the distance between the outer surface of the second side portion and the inner rear surface of the clamp corresponds to a third thickness of a third rectangular element that may be secured by the clamping system.

17. The adaptive clamping system of claim 16 wherein the first thickness is ¾ inch, the second thickness is ⅝ inch, and the third thickness is ½ inch.

18. A clamp system useful for securing a plurality of rectangular members to a wall, the clamp system comprising:
(a) a clamp comprising a front surface, a rear surface, and a top surface connecting the front and rear surfaces; a connecting element in the form of a length of material that defines an opening suitable for receiving a connecting component, the connecting element extending from a point at, or near the junction of the top surface and the rear surface; and a first screw opening extending through the top surface; and
(b) a connecting component, wherein at least a portion of the connecting component passes through the opening defined by the clamp connecting element.

19. The clamp system of claim 18 wherein the connecting component comprises a strap formed of webbing materials.

20. The clamp system of claim 19 wherein further comprising a claim coupled to an end of the strap, the clip defining a hook element and a clip screw opening.
